(19) United States
(12) Patent Application Publication
(10) Pub. No.: US 2015/0241342 A1
(43) Pub. Date: Aug. 27, 2015

(54) DIGITAL PHASE CONJUGATION USING MOVING TARGET AS GUIDE STAR

(71) Applicant: CALIFORNIA INSTITUTE OF TECHNOLOGY, Pasadena, CA (US)

(72) Inventors: Haojiang Zhou, Pasadena, CA (US); Benjamin Judkewitz, Berlin (DE); Changhuei Yang, Alhambra, CA (US)

(21) Appl. No.: 14/631,684

(22) Filed: Feb. 25, 2015

Related U.S. Application Data
(60) Provisional application No. 61/944,368, filed on Feb. 25, 2014.

(51) Int. Cl. G01N 21/47; G01N 21/59; G01N 21/01

(52) U.S. Cl. CPC G01N 21/47; G01N 21/01; G01N 21/59; G01N 2021/0181; G01N 2021/0106

(57) ABSTRACT

A method for irradiating a scattering medium, including irradiating a scattering medium with radiation from a laser, to form scattered radiation having a scattered field; measuring a difference in the scattered field caused by motion of a moving target in or behind the scattering medium; forming a phase conjugate of the difference to form a phase conjugate field; and irradiating the scattering medium with the phase conjugate field formed using one or more radiation modulating elements. Thus we present that movement of objects can be used as a novel guide star in Digital Optical Phase Conjugation (DOPC). By time reversal of difference of scattering fields of a moving target, light can be focused through scattering media.

### CROSS REFERENCE TO RELATED APPLICATIONS

This application claims the benefit under 35 U.S.C. Section 119(e) of co-pending and commonly-assigned U.S. Provisional Patent Application Ser. No. 61/944,368, filed on Feb. 25, 2014, by Benjamin Judkewitz, Haojiang Zhou, and Changhuei Yang, entitled “DIGITAL PHASE CONJUGATION USING MOVING TARGET AS GUIDE STAR,” attorneys' docket number 176.102-US-P1 (CIT-6825-P), which application is incorporated by reference herein.

### STATEMENT REGARDING FEDERALLY SPONSORED RESEARCH AND DEVELOPMENT

This invention was made with government support under OD007307 awarded by the National Institutes of Health. The government has certain rights in the invention.

### BACKGROUND OF THE INVENTION

1. Field of the Invention

This invention relates to focusing light through highly scattering media.

2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

Focusing light through highly scattering media is an important challenge in biomedical imaging, colloidal optics, and astronomy. When light propagates through strongly scattering samples, refractive index inhomogeneities scatter the light field in many directions. This was long thought of as a randomizing process, which precludes the formation of a sharp focus. However, by taking advantage of the deterministic nature of scattering, researchers in the field of complex wavefront shaping have demonstrated that light can be focused at an arbitrary location within and across scattering media—by shaping the input wavefront reaching the sample [1,2]. Because appropriate input wavefronts are complex and because they depend on sample structure as well as target location, determining them remains a key challenge. With direct optical access to the input plane and the focusing plane, wavefronts can be found with one of three strategies: iterative optimization [1,3-5], optical time reversal [6], or measuring and inverting the sample transmission matrix [7,8]. When there is no direct access to the target plane, e.g., when the target plane is hidden within the sample, physical guide stars such as beads can be placed within the sample and used as reference beacons [9-11]. Because this requires invasive insertion, recent research has focused on virtual, ultrasound-based guide stars relying on the acousto-optic [12-16] or the photo-acoustic effect [17-20]. However, all of these strategies are either limited by the acoustic resolution (tens of micrometers at best) or require many measurements, thereby increasing the recording time by orders of magnitude. Thus far, near-instantaneous time reversal at optical resolutions remains elusive.

Here, we introduce a new all-optical method, termed Time Reversal by Analysis of Changing wavefronts from Kinetic targets (TRACK), which achieves precise optical time reversal to a target hidden behind a scattering sample—without the need for acoustic guide stars. Unlike previous techniques, this method uses the motion of the target itself to serve as a guide star.

### SUMMARY OF THE INVENTION

One or more embodiments of the invention show optical time-reversal focusing using a new technique termed Time Reversal by Analysis of Changing wavefronts from Kinetic targets (TRACK). By taking the difference between time-varying scattering fields caused by a moving object and applying optical time reversal, light can be focused back to the location occupied or previously occupied by the object.

One or more embodiments of the invention further disclose an apparatus for irradiating a scattering medium and a method of fabricating the apparatus, the apparatus comprising a laser for irradiating a scattering medium with radiation to form scattered radiation having a scattered field, wherein a difference in the scattered field is caused by motion of a moving target in or behind the scattering medium; and one or more radiation modulating elements for forming a phase conjugate field used to irradiate the scattering medium, wherein the phase conjugate field is a phase conjugate of the difference.

The apparatus can further comprise a spatial light modulator (SLM) having one or more pixels comprising the one or more modulating elements or a deformable mirror device (DMD) having one or more actuators comprising the one or more modulating elements.

The apparatus can further comprise a sensor for measuring a first complex field of first scattered radiation and a second complex field of second scattered radiation, wherein the first scattered radiation comprises at least a portion of the scattered radiation when the moving target is at a first position, and the second scattered radiation comprises at least a portion of the scattered radiation when the moving target is at a second position in or behind a speckle field formed in the scattering medium when the radiation irradiates the scattering medium.

The apparatus can further comprise one or more processors for subtracting the first and second complex fields from each other to form the difference comprising a subtracted field, calculating the phase conjugate, and outputting the phase conjugate to the modulating elements such that the modulating elements are controlled to form the phase conjugate field that focuses at the second position.

The sensor can comprise a camera for measuring an interference of a portion of the scattered radiation with a reference beam. At least one of the processors can Fourier transform the interference to form a Fourier transform; filter out an interference term from the Fourier transform to form a filtered product; and inverse Fourier transform the filtered product to obtain the complex field of the portion of the scattered radiation.

The apparatus can further comprise a Digital Optical Phase Conjugation (DOPC) device comprising the modulating elements imaged onto the sensor comprising a camera and the one or more processors connected to the camera and the modulating elements, wherein the DOPC is positioned on a same side of the scattering medium as the incident radiation, to receive the scattered radiation comprising the radiation reflected and scattered from the scattering medium and the moving target.

The apparatus can further comprise a digital off-axis or on-axis holography system comprising the sensor and for measuring the complex fields.

The sensor can measure the second complex field, the processors can output the phase conjugate, and the modulating elements can form the phase conjugate field within a time such that the phase conjugate field focuses on at least a portion of the moving target at the second position or within a time of 50 milliseconds (50 ms).

In one or more embodiments, we demonstrate this approach with discretely moved objects as well as with particles in an aqueous flow, and obtain a focal peak-to-background strength of 204 in our demonstration experiments. For example, the moving target can have a cross-section having full width at half maximum (FWHM) of 50 micrometers or less, the phase conjugate field can form a focus in the scattering medium having a FWHM of 50 micrometers or less, and the focus can have a peak to background ratio of at least 300.

The scattering medium can a have a scattering coefficient μₛ of 30 mm⁻¹ or more, and/or the scattering medium can scatters the radiation such that an intensity of transmitted radiation per solid angle and as a function of azimuthal angle has a full width at half maximum of at least 0.075 radians. The scattering medium can comprise one or more biological cells, water, or atmosphere. The phase conjugate field can form a focus at a depth within the scattering medium that does not transmit a detectable ballistic component of the radiation within a detection threshold of 10⁻⁸ of the radiation's power.

The apparatus can further comprise a detector for measuring fluorescence emitted by the moving target in response to excitation by the phase conjugate field at a focus on the moving target at the second position.

In one or more embodiments, we further demonstrate that the generated focus can be used to noninvasively count particles in a flow-cytometry configuration—even when the particles are hidden behind a strong diffuser. One or more embodiments of the invention achieve optical time reversal and focusing noninvasively without any external guide stars, using just the intrinsic characteristics of the sample, paving the way to a range of scattering media imaging applications, including underwater and atmospheric focusing as well as noninvasive in vivo flow cytometry. The phase conjugate field can be formed to track the moving target or to focus at a specific location along a trajectory of the moving target.

One or more embodiments further disclose a method of irradiating a scattering medium, comprising irradiating a scattering medium (e.g., to form a speckle field in the scattering medium) with radiation from a laser, to form scattered radiation having a scattered field; measuring a difference in the scattered field caused by motion of a moving target in or behind the scattering medium; forming a phase conjugate of the difference to form a phase conjugate field; and irradiating the scattering medium with the phase conjugate field using one or more radiation modulating elements.

The method can comprise collecting, on a sensor, first scattered radiation comprising at least a portion of the scattered radiation when the moving target at a first position; collecting, on the sensor, second scattered radiation comprising at least a portion of the scattered radiation when the moving target has moved to a second position in or behind the speckle field; the measuring, in the sensor, comprising measuring a first complex field of the first scattered radiation and a second complex field of the second scattered radiation; subtracting, in a processor, the first and second complex fields from each other to form the difference comprising a subtracted field; calculating, in a processor, the phase conjugate; and outputting the phase conjugate to the modulating elements such that the modulating elements are controlled to form the phase conjugate field that focuses at the second position.

### BRIEF DESCRIPTION OF THE DRAWINGS

Referring now to the drawings in which like reference numbers represent corresponding parts throughout:

FIG. 1 illustrates the principle of focusing, showing a: recording, and b: conjugation, according to one or more embodiments.

FIG. 2 illustrates a set up according to one or more embodiments.

FIG. 3 illustrates a perspective view of a concise setup according to one or more embodiments, including sample and digital phase conjugation, wherein varying backscattered wavefronts due to a target's movement are captured by off-axis holography, the phase of the wavefront difference is time reversed by the digital optical phase-conjugation (DOPC) system, and diffuse light is focused back to the previous position of the target.

FIG. 4 illustrates a set up including a quality assurance arm according to one or more embodiments.

FIG. 5 illustrates focusing on a moving target through a scattering sample, according to one or more embodiments, showing a: target at position 1 (Pos. 1) (far off the illuminated field of view); b: target at position 2 (Pos. 2) (within the illuminated field of view); c: light is focused behind the diffuser; d-f: corresponding images recorded with the observing microscope for the setups in a-c, respectively; g and h are phase maps recorded at the camera imaging the SLM surface; i: difference of field in g and field in h, wherein the cross-section intensity distribution in f indicates a PBR of 204, scale bars in d-f are 100 micrometers (μm), and scale bars in g-i are 1 millimeter (mm).

FIG. 6 illustrates experimental data according to one or more embodiments, obtained using the set up of FIG. 2.

FIG. 7 illustrates point spread function (PSF) characterization, according to one or more embodiments, wherein the focal spot has a FWHM of 10 μm, by 11 μm , the size of the retro-reflective bead was 42 μm and the speckle size at the target was 2.6 μm, the fact that the focus was smaller than the bead illustrates that the focus shape approximates the reflectivity function (R(x_{b}), which is highest near the center of the retro-reflective spherical bead).

FIG. 8 illustrates target tracking images taken with the observing microscope, according to one or more embodiments, where a-c are images of targets at positions 1-3 in the laser speckle and d-f are phase conjugate foci at corresponding positions, g shows the set up for obtaining the data in a-c, and h shows the set up for obtaining the data in d-f.

FIG. 9 illustrates a timing chart for dynamic focusing on a moving target, according to one or more embodiments, and used to obtain the data in FIG. 8.

FIG. 10 illustrates optical flow cytometry in scattering media, according to one or more embodiments, showing a: schematic of the recording step, in which a focus is established as above; b: laser speckle shining on the microfluidic channel as imaged by the observing camera; c: time-reversed focus established with the help of the first bead; d: schematic of the particle counting setup; e: signal captured on the PMT with clear signals caused by fluorescent beads passing the focus, wherein both scale bars stand for 100 micrometers.

FIG. 11 illustrates a timing chart for the optical flow cytometry, according to one or more embodiments, used to obtain the data in FIG. 10.

FIG. 12 illustrates fluorescence spectrum of a cytometry bead and dichroic mirror transmission spectrum used to obtain the data in FIG. 11.

FIG. 13 illustrates angle distribution of the diffusing sample used to obtain the data in FIGS. 5 and 7, showing a: the speckle pattern captured 7.25 cm behind the diffusor attached to a pinhole, wherein the laser is shined through the pinhole, and b: distribution of intensity scattering angle, wherein the scale bar is 1 mm.

FIG. 14 illustrates TRACK focusing with an experimental setup analogous to the one in FIG. 3, except that the diffuser was replaced with 0.5 mm thick chicken breast tissue (μₛ: 30 mm⁻¹), showing a: laser speckle captured when the target is outside the speckle formed behind a 0.5 mm thick section of chicken breast, b: laser speckle when the target moves in, c: phase-conjugate focus, and d: cross section of the focus and wherein scale bars are 100 μm.

FIG. 15 is a flowchart illustrating a method for irradiating a moving target in a scattering medium, according to one or more embodiments.

FIG. 16 is a flowchart illustrating a method for measuring complex fields, according to one or more embodiments.

FIG. 17 illustrates comparison of TRACK to traditional reflective bead guide-stars, wherein we performed an experiment analogous to the one described in FIG. 3, but started by time-reversing just one wavefront M₁ (recorded when a reflective bead was present behind the scattering medium—see Equation 5), showing a: image recorded by the observing camera when such a wavefront was time-reversed and the focus is barely visible on top of the background and b: TRACK focusing with the difference wavefront (M₁-M₂) where M₂ was the wavefront recorded after the target was moved outside the field of view.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

A. Principle

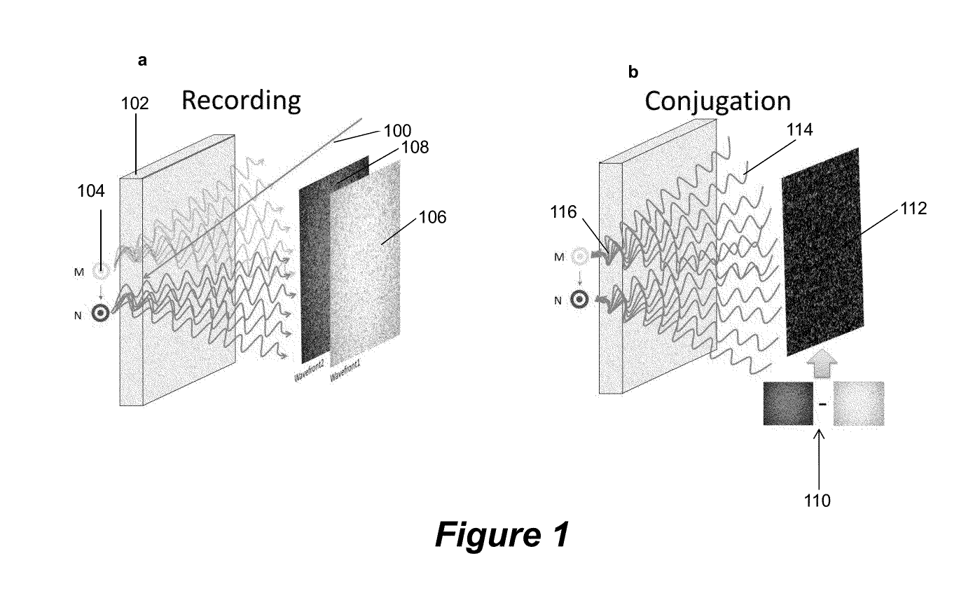

FIG. 1a shows a recording scheme when illuminating a laser beam 100 on the tissue 102 with a target 104 moving from position M to position N. By the framework of Vellekoop et al [5], we represent the speckles in the planes of the target at the position M and N by the electric field E_{M} and E_{N}. The electric field on the record plane from the backscattering of the tissue is E_{B}. The overall electric field E_{RM} on the record plane 106 when target is at position M is

E_{RM}=T_{TR}E_{M}+E_{B} (1)

where T_{TR} is the complete transmission matrix (with complex transmission values), which indicates the transform from target plane T to record plane R. Similarly, the overall electric field E_{RN} on the record plane 108 when target is at position N is

E_{RN}=T_{TR}E_{N}+E_{B} (2)

Ideally, if we collect all the scattering light, T_{TR} is unitary. As shown in the conjugation scheme in FIG. 1(b), if we differentiate 110 E_{RN} and E_{RM}, the field 112 is obtained, and if we apply phase conjugation to field 112, the differential conjugate electric field on target plane E_{DTR} is

E_{DTR}=T_{RT}(E_{RN}−E_{RM})*=T_{RT}(T_{RT})^{†}(E_{N}−E_{M})*=(E_{N}−E_{M}) (3)

In this way, E_{N}−E_{M} is recovered, which means phase conjugate light 114 is focused on M and N. If position M is off the laser speckle field, time reversal focusing will be only on N, e.g., focusing on the target. In reality, though complete time reversal is impossible, focusing 116 still can be achieved with presence of a background.

B. Apparatus

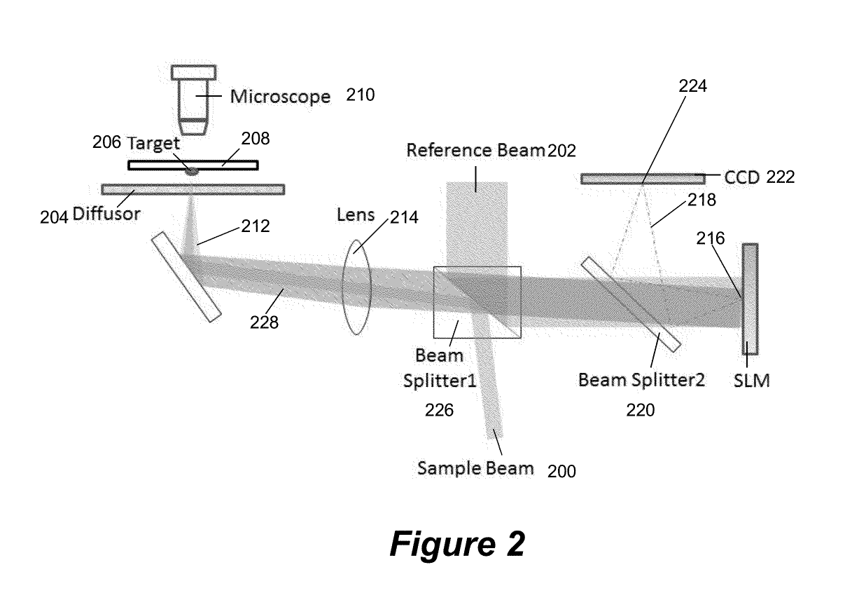

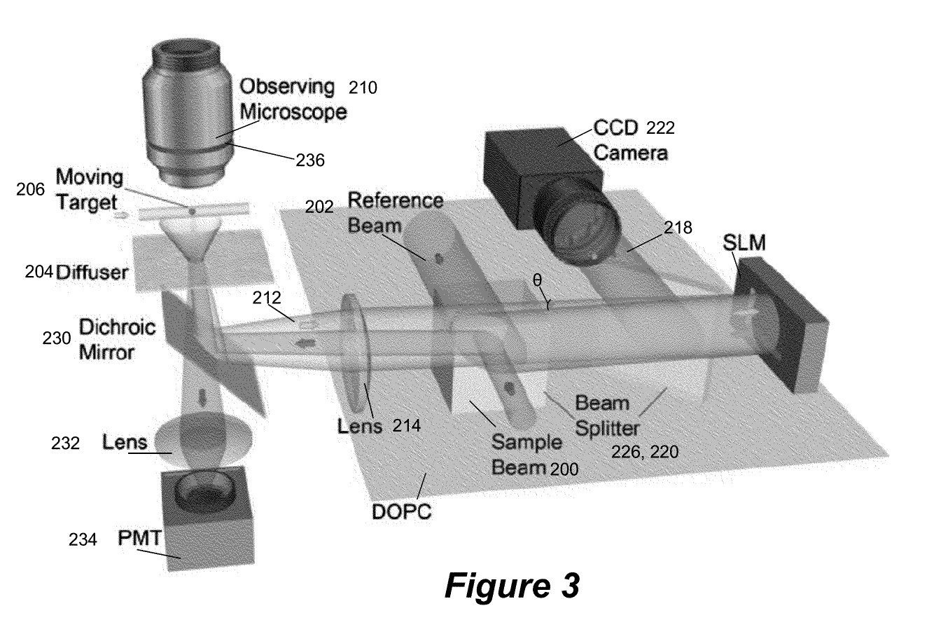

FIGS. 2 and 3 illustrate a set up according to one or more embodiments, comprising light (e.g, from a He—Ne laser having an emission wavelength of 632.8 nanometers (nm)) separated into two paths, i.e., the sample beam 200 and reference beam 202. Sample beam 200 is focused on the diffusor 204 with a target 206 about 15 millimeters (mm) behind. In one embodiment, the target 206 is a half shell aluminum coated retro-reflective bead with a diameter of 50 micrometers (μm) and he bead is oriented with the coating side to the incident beam 200, as a scattering sphere. The bead is attached to a glass slide 208 mounted on a two dimensional piezo-controlled stage for precise movement. A microscope 210 is placed behind the glass 208 slide to observe the conjugation result. A portion of light 212 through the diffusor 204 comprising light backscattered by the target 206 and light backscattered by the diffusor 208, is collimated by the lens 214 and interferes with reference beam 202 on the surface of a spatial light modulator (SLM). SLM, comprising pixels 216, is pixel-to-pixel imaged 218 using beam splitter 220 onto a charge-coupled device (CCD) 222 (CCD camera comprising pixels 224) to record the interference pattern between scattered beam 212 and reference beam 202. An angle θ is intentionally set (e.g., using beamsplitter 226) between the backscattering beam 212 and reference beam 202, so that digital off-axis holography can be applied to retrieve the scattering field E_{RM} 106 and/or E_{RN} 108. Time reversed beam 228 is achieved by playing back a conjugate phase of the difference field 112 on the SLM, as illustrated in FIG. 1b.

FIG. 3 illustrates the Digital Optical Phase Conjugation Device (DOPC) comprises camera 222, SLM, beamsplitter 226 for guiding sample beam 200 and reference beam 202, beamsplitter 220 for imaging SLM pixels onto the CCD 222, and lens 214. Also shown in FIG. 3 is a set up for measuring fluorescence emitted by the sample in response to illumination by the time reversed beam 228, comprising dichroic mirror 230, lens 232, and photomultiplier tube (PMT) 234.

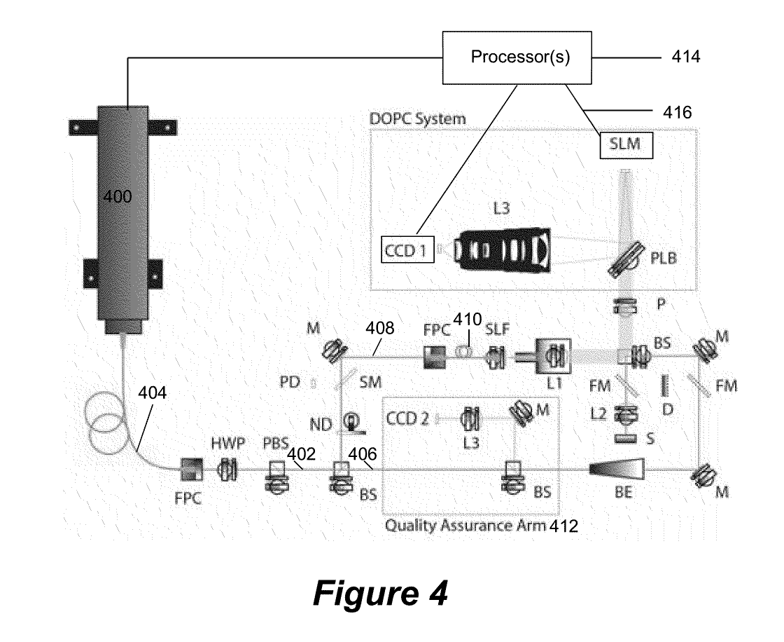

FIG. 4 illustrates another self-built optical system for collecting data, comprising ND-Neutral Density filter wheel, BE-Beam Expander, BS-Beam Splitter, BSH-Beam shutter, D-Diffuser, FM-Flip Mirror, FPC-Fiber Port Collimator, HWP-Half-wave Plate, L1,2,3-Lens 1,2,3, M-Mirror, P-Polarization Plate, PBS-Polarizing Beam Splitter, PD-Photo Detector, PLB-Plate beam splitter, S-Sample, SM-Sample Mirror, SLF-Spatial Light Filter, SLM-Spatial Light Modulator, and cameras CCD1 and CCD2.

The setup of FIG. 4 further illustrates a fiber-coupled semiconductor laser 400 emitting a 532 nm wavelength beam 402 of light to the system via optical fiber 404 and FPC. The polarization of the beam 402 was made horizontal (by a half-wave plate and polarizing beam splitter), which is in accordance with SLM modulation polarization. Beam splitter 1 split the incoming light into two beams, the sample beam 406 and the reference beam 408. The sample beam 406 was expanded by a laser expander BE for a suitable size of laser spot at the sample S. Reflected by mirrors and beam splitter, the sample beam 406 passed through lens 2 and was eventually reflected to the sample by a dichroic mirror, which was at a 45° angle to the horizontal plane. The sample was placed close to the focal plane of lens 2. Light backscattered by the sample was collimated to the SLM by lens 2.

The reference beam 408 passed through a neutral density filter and was coupled into a single-mode fiber 410 for spatial filtering. After exiting the fiber, the beam 408 was collimated by lens 1. Scattered light and reference light were combined by beam splitter before reaching the DOPC system.

FIG. 4 further shows that to assure the pixel-to-pixel alignment between the camera CCD1 and SLM and the performance of the DOPC system, a quality assurance setup or arm 412 was configured in the sample arm including two flipping mirrors, beam splitter, mirror, and camera 2 (CCD2). When flip mirrors were flipped up, the system was changed from the reflective mode to the transmission mode. When applying time reversal, we expected to observe a focus on camera 2. By tuning the position and tilting of the SLM, we optimized the intensity of the focus. In this way, a day-to-day precise alignment of the DOPC system was guaranteed.

Also shown in FIG. 4 are one or more processors 414 that are connected 416 to SLM, CCD1, and laser 400 for controlling timing and calculating fields and performing various other functionalities as discussed throughout this disclosure.

Backscattered Field Capture and Phase Retrieval

The backscattered field was recorded in a single-shot measurement by digital off-axis holography. In the DOPC system, the SLM surface was imaged on a CCD camera 222 with a precision of single pixel-to-pixel alignment. The camera 222 captured the interference pattern between the backscattered field (of the backscattered light 212) and the reference field (of the reference beam 202) at the SLM surface. Then, two dimensional (2D) fast Fourier transform (FFT) was applied to the captured images. In accordance with off-axis holography, an angle θ was set between the reference beam 202 and the sample beam 200 to separate the zero order, +1 order, and −1 order of the interference pattern in the Fourier spectrum. By filtering out the Direct Current (DC) term and −1 term and back transforming the spectrum, the scattered field from the sample was retrieved. For time reversal, this field was conjugated, and (since we used a phase-only SLM) the phase of the result was displayed on the SLM.

Reference Phase Correction

In digital phase conjugation, reference beam and SLM curvature will affect the conjugate phase map and thus the time reversal Peak to Background Ratio (PBR). By digitally modulating the SLM curvature to iteratively maximize the reflection from the SLM back into the single-mode fiber 410 in the reference beam arm, we can compensate for SLM curvature as well as reference beam phase errors [14]. A threefold enhancement is observed.

C. Results

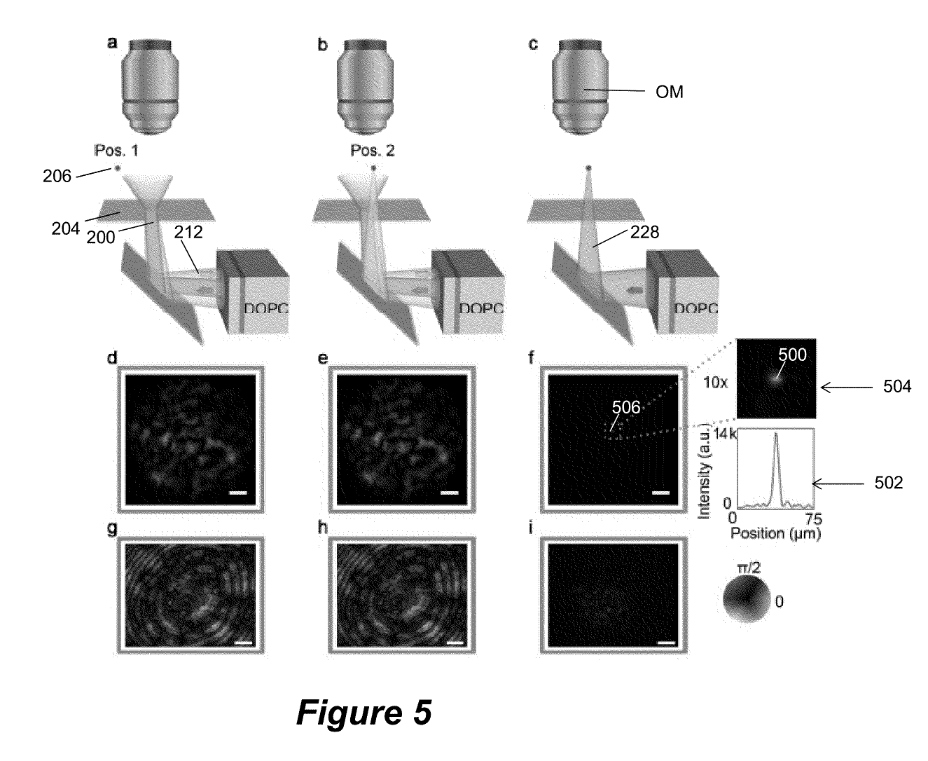

FIG. 5 illustrates testing noninvasive focusing of light through a scattering sample without using any extrinsic guide star, using the setup constructed as diagrammed in FIG. 3. We interpret optical scattering through our diffuser 204 as a linear process described by a complex spatial transmission matrix, T(xₐ; x_{b})[1]. This matrix defines the transformation of the optical field of sample beam 200 at an input plane with coordinates xₐ directly before the diffuser to an output plane with coordinates x_{b} behind the diffuser 204, where we have a moving target 206 moving between position 1 (Pos. 1) and position 2 (Pos. 2) and having a reflectivity function R(x_{b}). We assume that our digital phase-conjugation system (DOPC)is set up such that we can discretely measure and control the optical field along the input plane coordinates xₐ.

Our detect-and-refocus process comprises four primary steps. First, as illustrated in FIG. 5a, we illuminate the scatterer 204 with an input wave, U(xₐ), to reflect light off our target 206. U(xₐ) transforms into a speckle field at the output plane as defined by the transmission matrix: S(x_{b})=T(xₐ; x_{b})U(xₐ). A portion of the speckle field S(x_{b}) will hit our target object 206 with reflectivity function R(x_{b}). The target 206 object's backreflected optical field is thus the product E₁(x_{b})=R(x_{b})S(x_{b}). Note that R(x_{b})=0 and hence E₁(x_{b})=0 everywhere except along the target's finite spatial extent. We also assume S(x_{b})≠0 somewhere along our target to ensure a nonzero reflected signal.

Second, we measure the entire backscattered optical field of light 212 at the input plane, M₁(xₐ), also as depicted in FIG. 5a. Following linear optics, we split the backscattered field M₁(xₐ) into a sum of two components: one reflected from our target 206 object at the output plane, E₁(xₐ), and one originating from all other locations within the sample volume of diffusor 204, B(xₐ). The target-dependent component E₁(xₐ)is defined as the target-reflected optical field at the output plane, E₁(x_{b}), after it has backscattered to the input plane. Following the common assumption of a lossless scattering process, we may use our transmission matrix to express E′₁(xₐ) as

E′₁(xₐ)=T^{t}(xₐ; x_{b})E₁(x_{b}); (4)

where T^{t}, the transpose of T, represents the reverse process of scattering from the output to the input plane. The total measured field at the input plane is thus the sum

M₁(xₐ)=T^{t}(xₐ; x_{b})E₁(x_{b})+B(xₐ); (5)

where again B(xₐ) is the background optical field arising from all other locations within the sample.

Third, we measure a second backscattered field of light 212 at the input plane, M₂(xₐ), after the reflective target 206 object physically shifts a finite distance A across the output plane to Pos. 2. This measurement is depicted in FIG. 4b. A spatially shifted target will generate a new reflected field, E₂(x_{b})=R(x_{b}−Δ)S(x_{b}), which will again transform to the input plane via our transmission matrix and combine with a background field contribution to yield

M₂(xₐ)=T^{t}(xₐ; x_{b})E₂(x_{b})+B(xₐ) (6)

This equation implicitly assumes that T and B(xₐ) remain the same as for the first measurement for the target 206 at Pos. 1 illustrated in FIG. 5a, requiring the scattering sample 204 to be stationary (apart from target motion) at the time scale of the measurement interval.

Fourth, we digitally subtract our two measurements to effectively remove any background contribution and isolate the target-reflected signal:

M₂(xₐ)−M₁(xₐ)=T^{t}(xₐ; x_{b})[E₂(x_{b})−E₁(x_{b})] (7)

We compute the phase conjugate of this subtraction and display it on our digital optical phase-conjugation (DOPC) setup's spatial light modulator (SLM) to create the following field at the input plane: T^{†}(xₐ; x_{b})[E₂(x_{b})[E₂(x_{b})]*, where † denotes a conjugate transpose and * a complex conjugate. This field scatters from the sample's input to output plane to form electromagnetic radiation 228 having our final target-focused field, E_{f}(x_{b}), as shown in FIG. 5c.

$$\begin{matrix}{E}_{f} ( {x}_{b} ) = T ( {x}_{a} ; {x}_{b} ) {{T}^{†} ( {x}_{a} ; {x}_{b} ) [ {E}_{2} ( {x}_{b} ) - {E}_{1} ( {x}_{b} ) ]}^{*} \\ \approx {[ {E}_{2} ( {x}_{b} ) - {E}_{1} ( {x}_{b} ) ]}^{*} .\end{matrix} \qquad ( 8 )$$

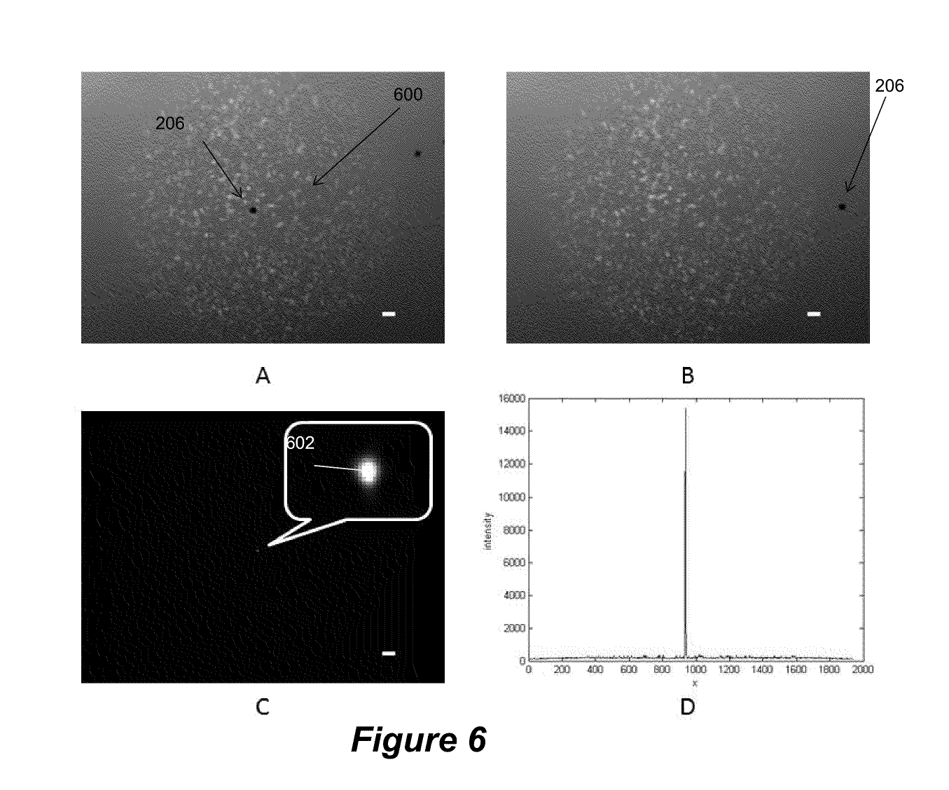

Here, we assume a complete scattering process to form the approximation T(xₐ; x_{b})T^{†}(xₐ; x_{b})≈I, the identity matrix. Conjugated light thus forms the field E₂−E₁ at the sample plane, implying light is focused to both shifted target positions. If the target was originally off the laser speckle field (i.e., E₁ is zero everywhere), a focus will appear only at its second location Pos. 2, which corresponds to our ability to refocus onto a moving object. This is illustrated in FIG. 6 using the apparatus of FIG. 2, showing scattering fields on the SLM recorded by off-axis holography when the target 206 is in the center (as shown in FIG. 6a) and off (as shown in FIG. 6b) the speckle field 600, respectively. The conjugate focus 602 is shown in FIG. 6c and a cross section showing the intensity as function of distance D in microns across the focus is shown in FIG. 6d. By measurement, a PBR up to 500 and FWHM 10 μm are achieved. PBR is measured by taking a picture of the focusing result with a camera. Then, a focus with a background is observed, wherein the focus has a much higher intensity than anywhere else and the background looks like a speckle field. The PBR can be calculated as peak intensity of the focus (If) divided by the average intensity of the background (Ib), i.e., PBR=If/Ib. There could be other methods to measure If and Ib, but the calculation would be the same.

Direct Observation of Optical Focusing in Reflection Mode

FIG. 3 further illustrates a Reflection-mode TRACK setup. To record backscattered light at the SLM plane, the camera 222 was pixel-to-pixel aligned to image the SLM surface, and wavefronts were measured by off-axis holography [21,22]. For demonstration, we created a sample consisting of 10 μm diameter polystyrene beads (target 206) behind a highly diffusing tape (diffusor 204). The beads were placed on a glass slide 208 that is 7 mm behind the diffuser 204, and the glass slide's 208 movement was two-dimensionally controlled by a piezo stage. To confirm the formation of a focus through scattering media, an observing microscope (OM) was set up to image the target plane from the back, as illustrated in FIGS. 5d-f. Importantly, in one or more embodiments, this microscope OM was only used for validation of successful focusing, but not to derive wavefronts or create the foci. We started by recording a backscattered wavefront without any targets 206 behind the diffuser 204 (as illustrated by the wavefront phase map in FIG. 5g recorded on CCD 222) and compared it to the wavefront measured when a target 206 was inside the illuminated field of view (as illustrated by the wavefront phase map in FIG. 5h recorded on CCD 222). As expected, both wavefronts were dominated by backscattering from the entire diffuser 204, while the relative difference of the wavefronts was 15% (relative average amplitude), as illustrated FIG. 5i. When we time reversed the difference wavefront by digital phase conjugation, the OM recorded a high-contrast focus 500 at the location of the target 206, as illustrated in FIG. 5f. The inset 502 of FIG. 5f includes a plot of the intensity profile (horizontal section across the peak), which shows a peak-to-background ratio (PBR) of 204 (inset 504 shows a 10× magnification of the area 506 indicated in FIG. 5f).

Moving Target Tracking Behind Scattering Media

A nearly ideal focusing is observed through scattering media. As confirmed by the experiment, implementation of object movement is a feasible and robust guide star in phase conjugation. We expect our work can provide more applications in deep tissue imaging.

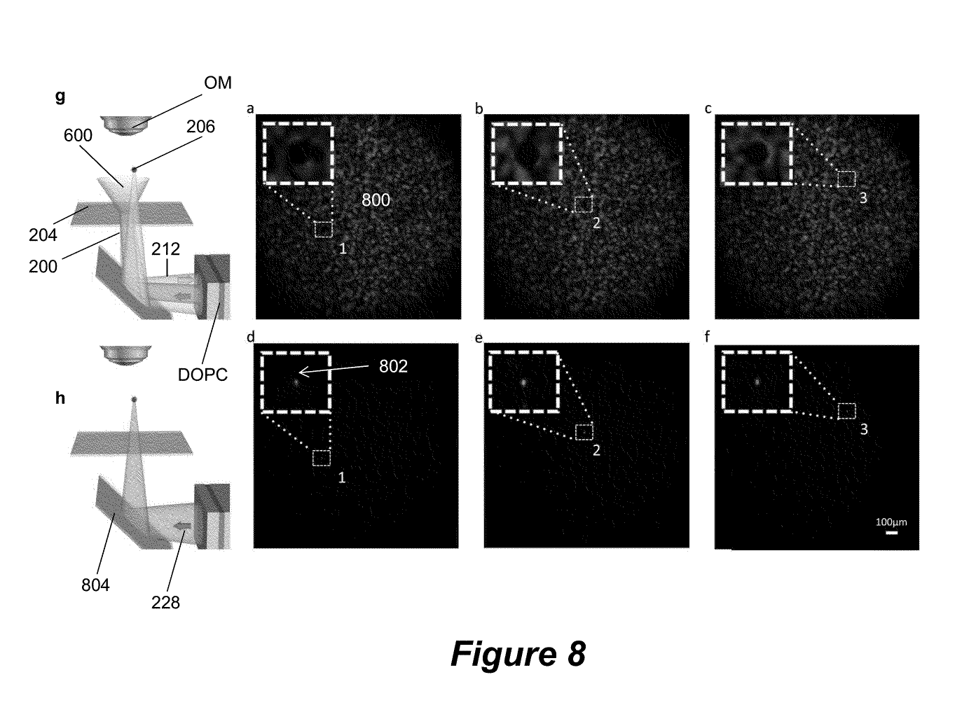

FIG. 8 illustrates that if we keep repeating the process illustrated in FIG. 3 or 5 with a continuously moving target 206, light will be focused dynamically on the target 206. In other words, we can track the moving target 206 through the scattering medium. To confirm this experimentally, we recorded a background wavefront at the SLM plane (with no target 206 bead in the illuminated area or speckle field 800), and subsequently moved a target 206 comprised of bead to multiple locations 1, 2, and 3 within the illuminated area or speckle field 800. At each position 1, 2, and 3 of the target 206 (as shown in FIGS. 8a-c, respectively), after recording the wavefront at the SLM plane, we subtracted the background wavefront from the current recorded wavefront at the SLM plane and time reversed the result to form a beam 228 having the time reversed field focused on the current location of the target 206 (as shown in FIGS. 8d-f which illustrate the focus 802 of the time reversed fields for the target at the locations 1, 2, 3 illustrated in FIGS. 8a-c, respectively). FIG. 8g shows the set up for obtaining the data in FIGS. 8a-c and FIG. 8h shows the set up for obtaining the data in FIGS. 8d-f, showing mirror 804 (e.g., dichroic mirror).

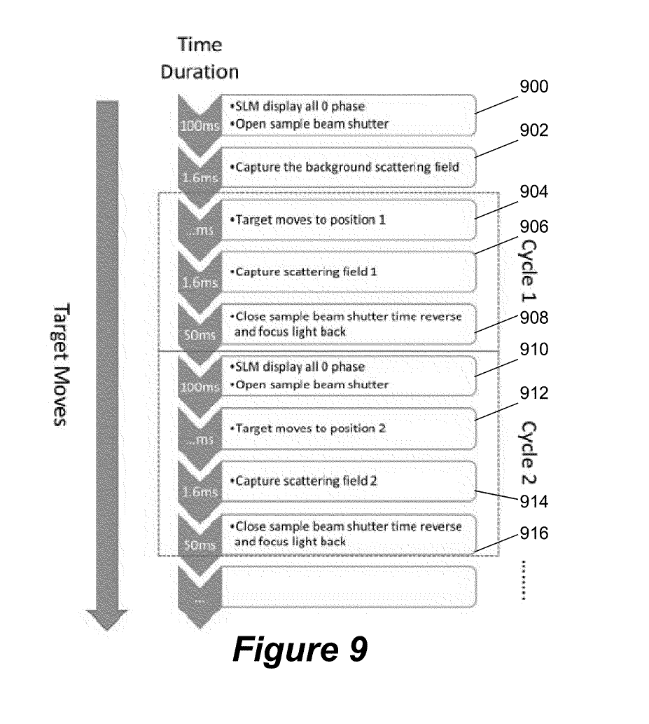

A detailed timing diagram for the system is shown in FIG. 9, with the following sequential steps and time durations in milliseconds (ms):
Step 1 (900): SLM displaying all 0 phase and opening sample beam shutter in a time of 100 ms or less.
Step 2 (902): Capturing the background scattering field in a time of 1.6 ms or less.
Step 3 (904): Target moves to position 1.
Step 4 (906): Capture scattering field 1 in a time of 1.6 ms or less.
Step 5 (908): close sample beam shutter and time reverse and focus light back, in a time of 50 ms or less.
Step 6 (910) SLM displaying all 0 phase and opening sample beam shutter in a time of 100 ms or less.
Step 7 (912): Target moves to position 2.
Step 8 (914): Capture scattering field 2 in a time of 1.6 ms or less.
Step 9 (916): close sample beam shutter and time reverse and focus light back, in a time of 50 ms or less.
   Further cycles can be repeated as desired.

In this experiment, a 50 μm diameter retro-reflective target 206 bead was 14 mm behind the diffuser 204.

Optical Flow Cytometry in Scattering Media

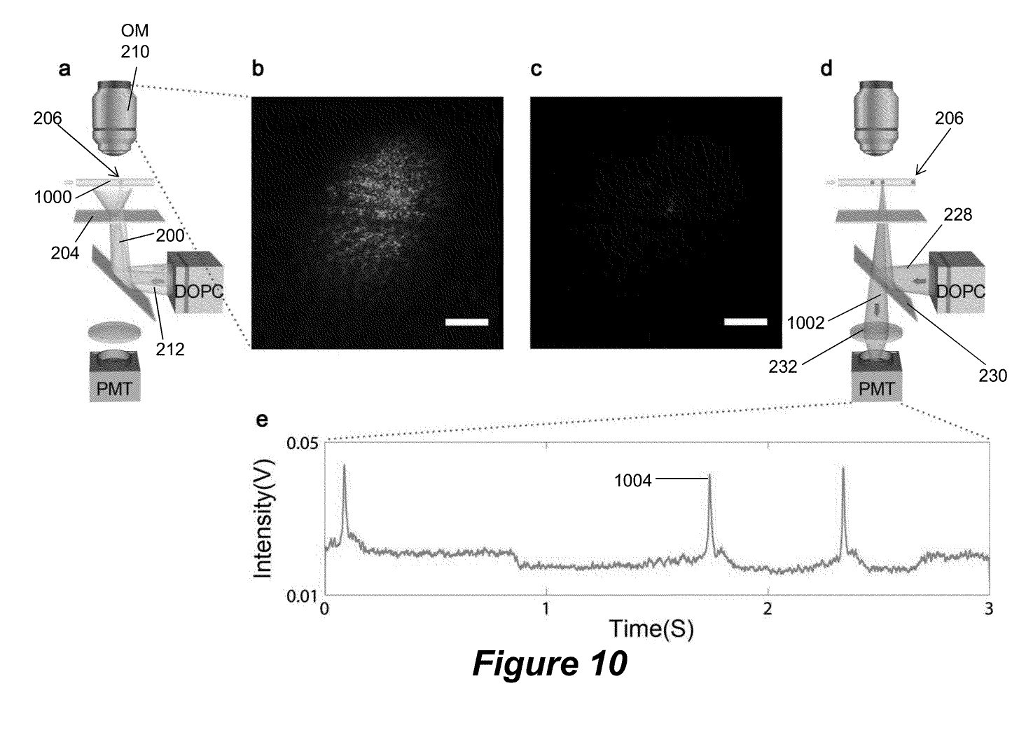

To mimic an in vivo flow-cytometry scenario, we placed a microfluidic channel 1000 behind the diffuser 204, as illustrated in FIG. 10. Two kinds of beads were used for the target 206 in this experiment: nonfluorescent polystyrene beads as guide stars, and fluorescent beads to be counted in a flow cytometry-type setup. Repeating the first process (“direct observation of optical focusing,” above) in a microfluidic channel 1000, we recorded two scattering fields with the target 206 comprising a guide star bead outside and inside the illuminated area (FIG. 10a). FIG. 10b shows the speckle field in the microfluidic channel as a result of illumination using sample beam 200 and as viewed in the OM. We then phase conjugated the difference wavefront and observed a focus of the time reversed beam 228 at the exact position of the guide bead (as shown in FIGS. 10c and 10d). From the cross-section intensity distribution, we measured a PBR of 134 and a full width half-maximum (FWHM) of 8.9 μm. After formation of the focus, the targets 206 comprising fluorescence beads were flown at a speed of 5 centimeters per second (cm/s) through the microfluidic channel 1000, the time reversed beam 228 focusing on the fluorescence beads and causing the fluorescence beads to fluoresce and produce a fluorescence beam 1002, wherein the time-varying fluorescence signal of the beam 1002 was recorded by a single-channel photomultiplier tube (PMT), as illustrated in FIG. 10e. The PMT trace contained clearly detectable signals 1004 that corresponded to fluorescent beads passing the focus. Illumination, phase conjugation, and fluorescence detection by the PMT all occurred on the same side of the scattering sample in a reflection geometry.

For fluorescence signal capture in the flow-cytometry experiment, we used orange fluorescent (540/560) polystyrene microspheres obtained from Life Technology. As shown in FIG. 10c, the targets 206 comprising orange fluorescence 1002 from the beads propagated through the diffuser 204 along with diffuse backscattered light 212 at 532 nm. Colors were separated by the dichroic mirror 230 (a 532 edge pass filter, model Di02-R532-25×36 from Semrock). Underneath the dichroic mirror 230, a lens 232 images the surface of the diffuser 204 to a compact PMT.

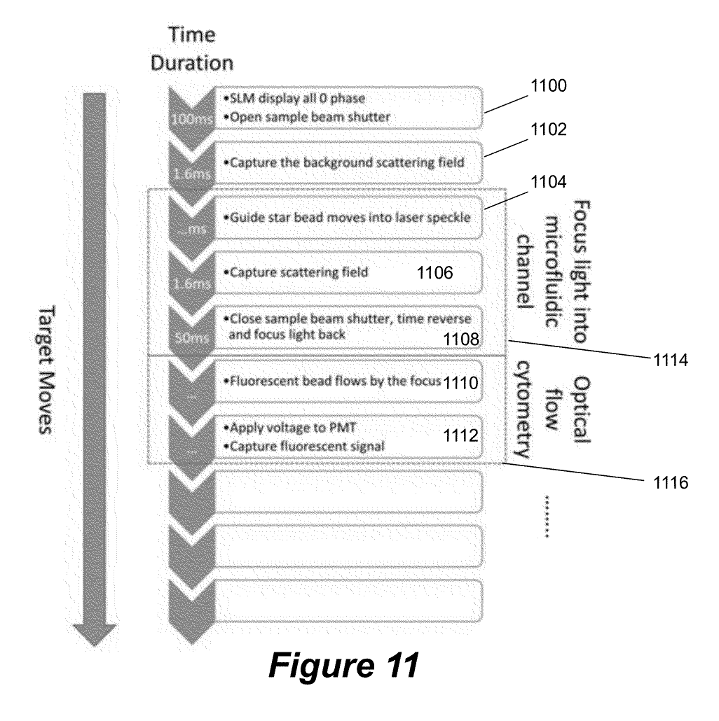

A detailed timing diagram for the system is shown in FIG. 11.
Step 1 (1100): SLM displaying all 0 phase and opening sample beam shutter in a time of 100 ms or less.
Step 2 (1102): Capturing the background scattering field in a time of 1.6 ms or less.
Step 3 (1104): Guide star bead moves into laser speckle.
Step 4 (1106): Capture scattering field in a time of 1.6 ms or less.
Step 5 (1108): close sample beam shutter and time reverse and focus light back, in a time of 50 ms or less.
Step 6 (1110) Fluorescent bead flows by the focus.
Step 7 (1112): Apply voltage to PMT and capture fluorescent signal.

Steps 1104-1108 comprise focusing light into the microfluidic channel (1114) and steps 1110-1112 comprise performing optical flow cytometry (1116).

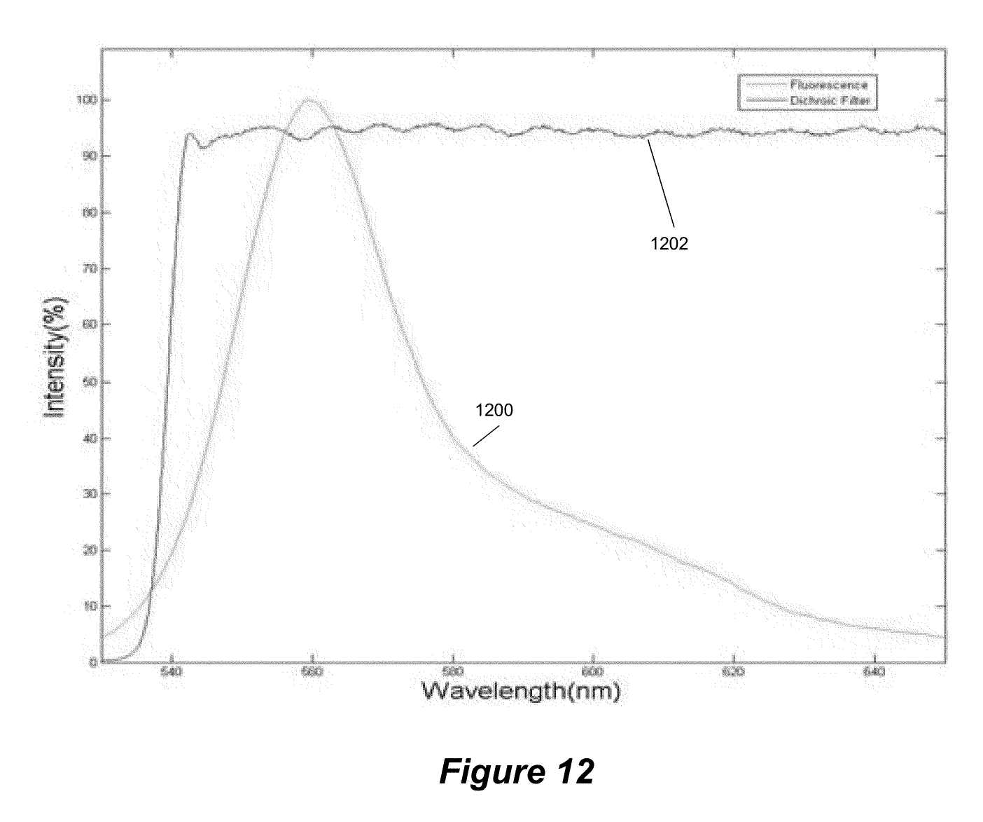

The fluorescence spectrum 1200 of the sample and the transmission spectrum 1202 of edge pass dichroic filter are shown in FIG. 12, plotted transmitted intensity as a function of wavelength of light in nanometers (nm).

A median filter was used to filter the signal shown in FIG. 10e.

Specimens

The target 206 comprising a polystyrene bead was obtained from Life Technology. The target 206 comprising a retro-reflective bead, which consisted of aluminum coated 50 μm glass spheres, was obtained from Cospheric.

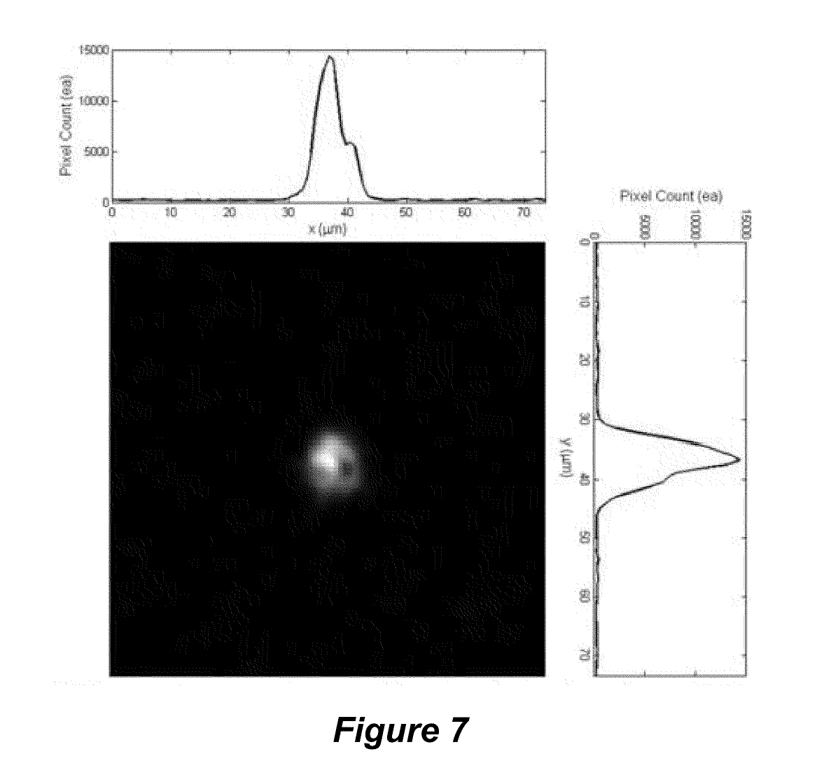

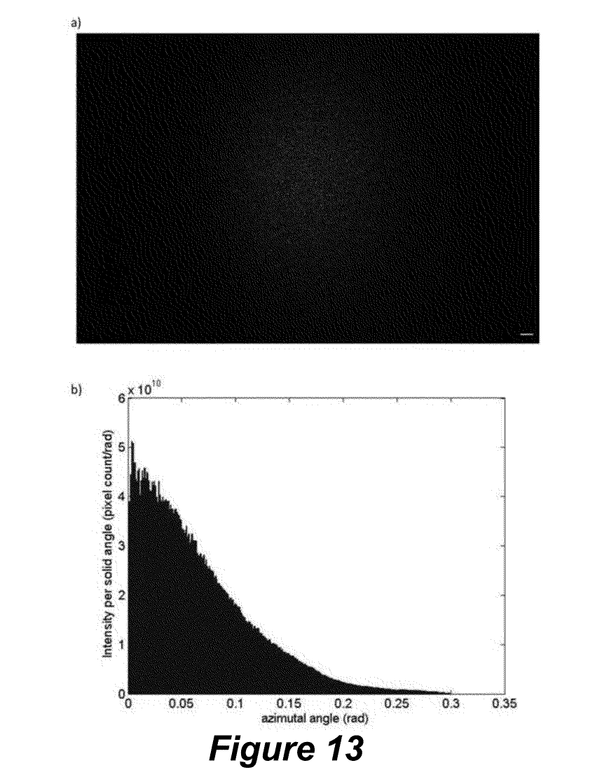

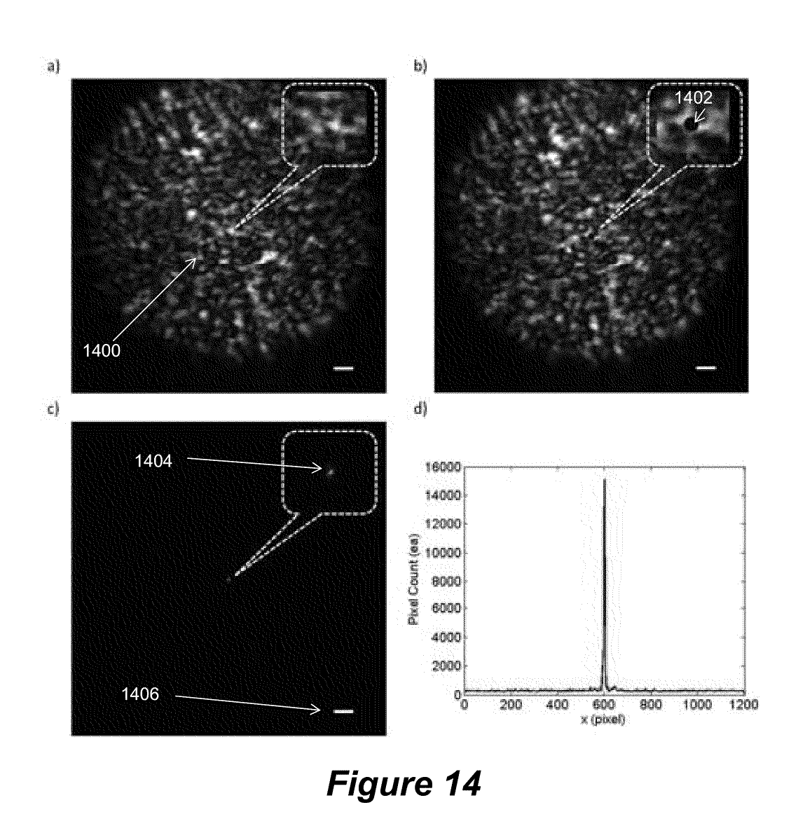

The diffusors 204 used to obtain the data illustrated in FIGS. 5-8 and 10 are adhesive backed, highly diffusing films (3M Scotch model no. 810, ˜60 micrometers (μm) thick), which did not transmit a detectable ballistic component (measured with a detection threshold of 10⁻⁸ of the illumination power). For these data, the diffusor 204 was used as a random phase plate diffuser whose angle scattering distribution is plotted in FIG. 13. To show that our results can be extended to biological samples, we performed TRACK experiments through a 0.5 millimeter (mm) thick section of ex vivo chicken muscle tissue (scattering coefficient μₛ=30 mm⁻¹ and anisotropy parameter g=0.965 [14]). The results of this experiment are shown in FIG. 14.

FIG. 14 shows TRACK focusing with an experimental setup analogous to the one in FIG. 3, except that the diffuser 204 was replaced with 0.5 mm thick chicken breast tissue (μₛ: 30 mm⁻¹), wherein FIG. 14a shows laser speckle 1400 captured when the target 206 is outside the speckle formed behind a 0.5 mm thick section of chicken breast, FIG. 14b shows laser speckle when the target 1402 moves inside the laser speckle, FIG. 14c shows the phase-conjugate focus 1404, and FIG. 14d shows a cross section of the focus (intensity of fluorescence measured as a function of position x in microns across the focus 1404), and wherein the scale bars 1406 are 100 μm.

Process Steps

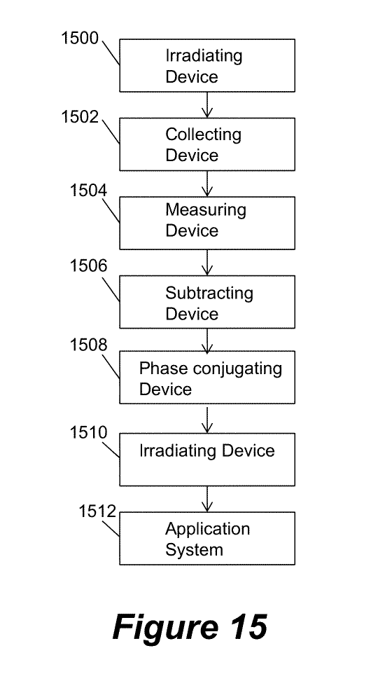

FIG. 15 illustrates a method for irradiating a moving target in or behind or obscured by a scattering medium and/or fabricating an apparatus for irradiating the moving target. The method can comprise the following steps.

Block 1500 represents providing means or a device (e.g., Electromagnetic (EM) radiation source, laser 400 such as a laser diode, semiconductor laser diode, emitting any wavelength) for irradiating a scattering medium 204, 1000 with (e.g., coherent) EM radiation 200 to form scattered (e.g., EM) radiation 212 having a scattered (e.g., EM) field. The irradiating can form a speckle field 800 in the scattering medium 204.

The scattering medium can be selected to have a scattering coefficient μₛ of 30 mm⁻¹ or more. The scattering medium can comprise one or more biological cells (e.g., blood cells) or tissue (e.g., animal or human tissue/cells), water (e.g., ocean, lake, gas, or vapor), or atmosphere.

The scattering medium can be selected such that it scatters the radiation such that an intensity of transmitted radiation per solid angle and as a function of azimuthal angle has a full width at half maximum of at least 0.075 radians.

The phase conjugate field can form a focus at a depth within the scattering medium that does not transmit a detectable ballistic component of the radiation within a detection threshold of 10⁻⁸ of the radiation's power.

The step can comprise providing a sample holder for supporting the scattering medium and target.

Blocks 1502-1506 provide an example of measuring a difference 112 in the scattered field caused by motion of a moving target 206 in or behind the scattering medium.

Block 1502 represents providing collection device or means (e.g., camera 222, sensor, or wavefront sensor) for collecting first scattered radiation (e.g., background) comprising at least a portion of the scattered radiation 212 when the moving target is at a first position M or Pos. 1 (e.g, in or behind the speckle field 800 or outside and not behind the speckle field 800). The means or collection device can also collect second scattered radiation comprising at least a portion of the scattered radiation 212 when the moving target has moved to a second position N or Pos. 2 in or behind the speckle field.

Block 1504 represents means or a device (e.g., the camera, a reference beam 202, and one or more processors 414) for measuring a first complex (e.g., EM) field of the first scattered radiation and a second complex (e.g., EM) field of the second scattered radiation. The measurement can use any method or sensor (e.g., wavefront sensor) that enables measurement of phase and/or amplitude of the scattered fields.

The means can comprise a digital off-axis or on-axis or in-line holography system comprising the sensor and for measuring the complex fields.

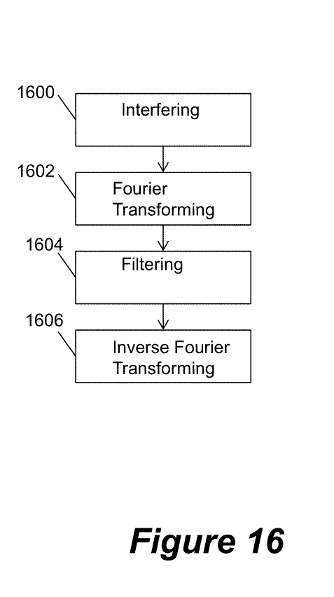

FIG. 16 illustrates how the measuring of the first scattered radiation or the second scattered radiation can comprise interfering or forming interference of a portion of the scattered radiation with the (e.g, on axis, in-line, or off-axis) reference beam and on the camera, as represented in Block 1600; Fourier transforming, in at least one of the processors 414, the interference pattern to form a Fourier transform, as represented in Block 1602; filtering out, in at least one of the processors 414, an interference term (e.g., filtering out the +1 order leaving the −1 order and the 0 order, or filtering out the −1 order leaving the +1 order and the 0 order) from the Fourier transform to form a filtered product, as represented in Block 1604; and inverse Fourier transforming, in at least one of the processors 414, the filtered product to obtain the complex field (phase and magnitude), as represented in Block 1606. The measuring can comprise measuring the magnitude or amplitude E₀ and the phase Φ of the complex scattered field E, and the scattered complex field can be expressed mathematically as E=E₀e^{-iΦt}, where i is the imaginary number \sqrt{−1}.

Block 1506 represents means or a device (e.g., at least one off the processors 414) for subtracting the first and second complex fields from each other to form a subtracted field 112.

Block 1508 represents providing a phase conjugating device (e.g., at least one of the processors 414) for forming a phase conjugate (or time reversed field or copy) of the difference (e.g., subtracted field) to form a phase conjugate field of phase conjugate radiation 228. The processor can calculate the phase conjugate and output the phase conjugate to modulating elements such that the modulating elements 216 are controlled to form the phase conjugate field or time reversed copy that focuses at the second position (position of the moving target when it scattered the light). For example, if the difference field 112 is described by F₀e^{-idΦt}, where F₀ is an amplitude, dΦ is the phase and i is the imaginary number \sqrt{−1}, the phase conjugate can be formed by changing the sign of the phase dΦ to obtain the phase conjugate field described by F₀e^{+idΦt}. The amplitude of the phase conjugate can be selected as desired. Note that if we choose the +1 term in the Fourier transform of the off axis interference, the phase retrieved is the phase of the difference field, and if we choose the −1 term in the Fourier transform, the phase retrieved is already the conjugate of the difference field.

Block 1510 represents providing radiation modulating elements 216 (e.g., in a spatial light modulator (SLM) or deformable mirror device (DMD)) for irradiating the scattering medium with the phase conjugate field. The phase conjugate field can focus at the second position N. The step can comprise at least one of the processors 414 setting one or more pixels 216 (comprising the modulating elements) of the SLM or setting one or more actuators (comprising modulating elements of the DMD) to form phase conjugate radiation 228 having the phase conjugate field modulated by the elements 216. The modulating elements can modulate a blank reference beam 202 to form the phase conjugate radiation 228.

In one or more embodiments, if it is desired to focus the phase conjugate field on target, the target cannot move too far during the process steps. For example, it may be desired for the moving target to move a distance smaller than a cross-sectional dimension (e.g., smaller than the diameter) of the target during a time taken to perform the steps or functions of measuring the second complex field, providing the subtracted field, and forming the phase conjugate field. Thus, the steps or functions for measuring the second complex field, providing the subtracted field, and forming the phase conjugate field, can be performed within a time such that the phase conjugate field focuses on at least a portion of the moving target at the second position and/or within a time of 50 milliseconds. The moving target can be selected to have a speed that is limited such that the phase conjugate field focuses on at least a portion of the moving target at the second position.

The moving target can have a cross-section having full width at half maximum (FWHM) of 50 micrometers or less, the phase conjugate field can form a focus in the scattering medium having a FWHM of 50 micrometers or less, and the focus can have a peak to background ratio of at least 200, at least 300, or at least 500.

Block 1512 represents an apparatus that can be fabricated using the above steps.

The apparatus can comprise a laser 400 for irradiating a scattering medium with radiation 200 to form scattered radiation 212 having a scattered field, wherein a difference in the scattered field is caused by motion of a moving target 206 in or behind the scattering medium 204; and one or more radiation modulating elements 216 for forming a phase conjugate field used to irradiate the scattering medium 204, wherein the phase conjugate field is a phase conjugate of the difference.

The apparatus can comprise a DOPC system to collect and measure the scattered light. The DOPC can comprise the SLM or DMD and the camera can comprise a scientific CMOS camera or digital camera. The at least one processor 414 can comprise a field programmable gate array (FPGA) that can be embedded with the SLM/DMD and camera in the DOPC. The SLM, DMD, digital camera, and the at least one processor can be positioned, connected (e.g., electrical or optical or electromagnetic coupling or connection), and selected for performing the steps or functions described above and/or for measuring the second complex field, providing the subtracted field, and forming the phase conjugate field within desired time frames. A controller (e.g., processor) can be provided to control the timing of the various steps 1500-1510.

The DOPC device can comprise the modulating elements imaged onto the sensor comprising the camera and the one or more processors connected to the camera and the modulating elements, wherein the DOPC is positioned on a same side of the scattering medium as the incident radiation, to receive the scattered radiation comprising the radiation reflected and scattered from the scattering medium and the moving target (reflection geometry).

Further information on the DOPC system according to one or more embodiments can be found in [25-26]. The DOPC used to obtain the data (e.g., in FIGS. 5, 6, 7, 8, 10, and 14) and perform the method according to one or more embodiments of the present invention (e.g., the method as illustrated in FIG. 15) can comprise the camera 222 in [27] and the SLM in [28]. The processors or controller 414 can be a computer and can operate using software. For example the processors/computer can run on Matlab and the method and/or DOPC (including the SLM and camera) can be driven, addressed, or controlled through Matlab or a Matlab interface, for example.

Block 1514 represents an application system (e.g., imaging system, flow cytometer) using the focusing of the phase conjugate field at the second position. The step can comprise imaging the target in or behind the scattering medium using the phase conjugate field at the second position. The step can comprise measuring fluorescence (e.g., EM radiation) 1002 (and providing a detector (PMT) for measuring the fluorescence) emitted by the moving target in response to excitation by the phase conjugate field at a focus on the moving target at the second position. The step can comprise performing flow cytometry of the target and/or the scattering medium using the phase conjugate field at the second position. The step can comprise using the phase conjugate field to trigger a chemical reaction at the second position (e.g., performing photodynamic therapy, the chemical reaction starting in response to the phase conjugate field). The phase conjugate field can be formed to track the moving target or to focus at a specific location along a trajectory of the moving target.

The radiation and fields referred to herein can comprise electromagnetic (EM) radiation and EM fields, respectively. Alternatively, the fields can comprise time varying electric fields or time varying magnetic fields provided by an electric field or magnetic field source in Block 1500.

Further information on one or more embodiments of the invention can be found in [29].

Further Considerations

Focusing light through scattering media has been a longstanding goal of biomedical optics.

Digital Optical Phase Conjugation (DOPC) [1, 2] is a promising technique to image through scattering media. A key of the technology is to achieve focusing inside the tissue. To attain that, various guide stars are implemented. Ultrasound combined with phase conjugation, is proposed as time-reversed ultrasonically encoded (TRUE) optical focusing[3]. Second harmonic radiation emitted by nanoparticle is also reported[4].

While wavefront shaping and optical time-reversal techniques can in principle be used to focus light across scattering media, achieving this within a scattering medium with a noninvasive and efficient reference beacon, or guide star, remains an important challenge.

In this work we provided, to the best of our knowledge, the first demonstration of time-reversed optical focusing through scattering media by using the motion of a target object as a guide star—a technique we call TRACK. In one or more embodiments of the present invention, we utilize the movement of objects behind the scattering media as a kind of novel guide star, and demonstrate a time reversal focusing with 10 μm in diameter and 500 peak to background (PBR) ratio.

First, TRACK will focus on all backscattering targets that moved between the two wavefront recordings. If the goal is to focus on a single target or bead, only one moving backscattering bead should be within the illuminated area.

Second, we would like to point out that our experimental setup associated with the experimental findings shown in FIGS. 5, 8, and 10 contains a microscope objective OM 210 and camera 236 (outlined in green in FIG. 3) that allowed us to directly observe the space after the diffuser 204. We used that imaging system to directly observe and verify that the TRACK focus was achieved. In practical applications, it is unlikely that such an observation perspective would be available. In most of the application scenarios, our only access to the target 206 of interest would be on one side of the diffusing medium, in a reflection geometry. A good case in point would be the task of reflection-mode focusing of light through skin and into a blood vessel. The reflection-mode focusing results presented here show that focusing light in this geometry is feasible. For example, upon creating the time-reversed optical focus (FIG. 10), we can observe the passage of the targets 206 comprising fluorescent beads through the microfluidic channel 1000 by simply observing the upticks 1004 in fluorescence scattered back through the diffuser 204.

Another important trade-off space this method introduces is an intrinsic relationship between focus spot size and achievable PBR. Mathematically, these two quantities are related to each other through the number of optical modes that the DOPC can capture and control during playback [23]:

$${PBR}_{phase - only} \approx \frac{π}{4} \frac{{N}_{SLM}}{{N}_{target}}$$

where N_{SLM} indicates modes on the SLM from the scattering of the target 206 and N target represents the number of modes modulated by the target in the speckle plane. The above formula contains a π/4 factor because the DOPC in this set of experiments is a phase-only modulator system. For the experimental setup used for FIG. 5, the above formula predicts a focus PBR of 390—a quantity that is consistent with our experimental result of 204 (as measured in FIG. 5), indicating a time-reversal efficiency of >50%. The above formula leads to an interesting consequence. By using smaller target objects, we can effectively create a tighter optical focus and simultaneously boost the PBR. However, we caution that the use of ever smaller target objects will lead to a weaker initial scattering signal arriving at the DOPC and in turn degrade the time-reversed wavefront in the presence of noise. This will then reduce the focus PBR.

As the different sets of experimental results reported in FIGS. 8 and 10 show, this method can be used to create a time-reversed focus that tracks with the target object, or to create a fixed and static focus at a specific location along the trajectory of the object. Each of these focusing types is useful for different applications: dynamic tracking can potentially be useful for following moving targets in deep ocean or convective atmosphere environments, while the static focus would be most useful for flow-cytometry-type applications.

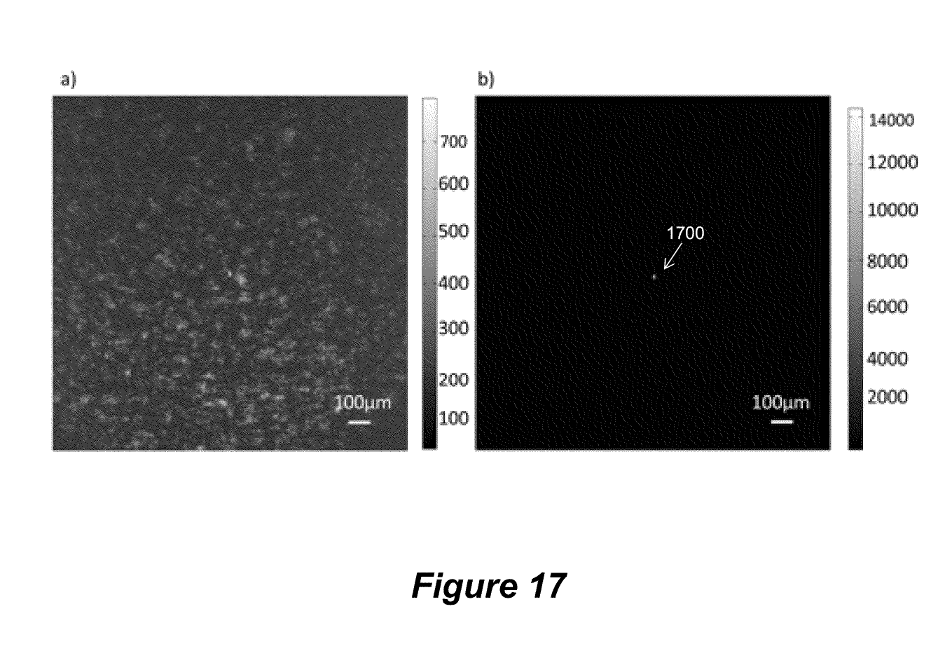

To compare TRACK to traditional reflective bead guide-stars, we performed an experiment analogous to the one described in FIG. 5, but started by time-reversing just one wavefront M₁ (recorded when a reflective bead was present behind the scattering medium—see Equation (5)). FIG. 17a shows the image recorded by the observing camera 236 when such a wavefront was time-reversed. The focus is barely visible on top of the background. FIG. 17b shows TRACK focusing with the difference wavefront (M₁-M₂) where M₂ was the wavefront recorded after the target was moved outside the field of view.

### REFERENCES

The following references are incorporated by reference herein.

[1] I. M. Vellekoop and A. P. Mosk, “Focusing coherent light through opaque strongly scattering media,” Opt. Lett. 32, 2309-2311 (2007).

[2] A. P. Mosk, A. Lagendijk, G. Lerosey, and M. Fink, “Controlling waves in space and time for imaging and focusing in complex media,” Nat. Photonics 6, 283-292 (2012).

[3] I. M. Vellekoop, A. Lagendijk, and A. Mosk, “Exploiting disorder for perfect focusing,” Nat. Photonics 4, 320-322 (2010).

[4] D. B. Conkey, A. M. Caravaca-Aguirre, and R. Piestun, “High-speed focusing of light through dynamic turbid media,” in Imaging and Applied Optics Technical Papers, OSA Technical Digest (online) (Optical Society of America, 2012), paper CTu4B.6.

[5] H. Yilmaz, W. L. Vos, and A. P. Mosk, “Optimal control of light propagation through multiple-scattering media in the presence of noise,” Biomed. Opt. Express 4, 1759-1768 (2013).

[6] Z. Yaqoob, D. Psaltis, M. S. Feld, and C. Yang, “Optical phase conjugation for turbidity suppression in biological samples,” Nat. Photonics 2, 110-115 (2008).

[7] S. Popoff, G. Lerosey, M. Fink, A. C. Boccara, and S. Gigan, “Image transmission through an opaque material,” Nat. Commun. 1, 81 (2010).

[8] Y. Choi, C. Yoon, M. Kim, T. Yang, C. Fang-Yen, R. Dasari, K. Lee, and W. Choi, “Scanner-free and wide-field endoscopic imaging by using a single multimode optical fiber,” Phys. Rev. Lett. 109, 203901 (2012).

[9] C.-L. Hsieh, Y. Pu, R. Grange, and D. Psaltis, “Digital phase conjugation of second harmonic radiation emitted by nanoparticles in turbid media,” Opt. Express 18, 12283-12290 (2010).

[10] I. M. Vellekoop, M. Cui, and C. Yang, “Digital optical phase conjugation of fluorescence in turbid tissue,” Appl. Phys. Lett. 101, 81108 (2012).

[11] X. Tao, J. Crest, S. Kotadia, O. Azucena, D. C. Chen, W. Sullivan, and J. Kubby, “Live imaging using adaptive optics with fluorescent protein guide-stars,” Opt. Express 20, 15969-15982 (2012).

[12] X. Xu, H. Liu, and L. V. Wang, “Time-reversed ultrasonically encoded optical focusing into scattering media,” Nat. Photonics 5, 154-157 (2011).

[13] P. Lai, X. Xu, H. Liu, Y. Suzuki, and L. V. Wang, “Reflection-mode time-reversed ultrasonically encoded optical focusing into turbid media,” J. Biomed. Opt. 16, 080505 (2011).

[14] Y. M. Wang, B. Judkewitz, C. A. DiMarzio, and C. Yang, “Deeptissue focal fluorescence imaging with digitally time-reversed ultrasound-encoded light,” Nat. Commun. 3, 928 (2012).

[15] K. Si, R. Fiolka, and M. Cui, “Fluorescence imaging beyond the ballistic regime by ultrasound pulse guided digital phase conjugation,” Nat. Photonics 6, 657-661 (2012).

[16] B. Judkewitz, Y. M. Wang, R. Horstmeyer, A. Mathy, and C. Yang, “Speckle-scale focusing in the diffusive regime with time reversal of variance-encoded light (TROVE),” Nat. Photonics 7, 300-305 (2013).

[17] F. Kong, R. H. Silverman, L. Liu, P. V. Chitnis, K. K. Lee, and Y. C. Chen, “Photoacoustic-guided convergence of light through optically diffusive media,” Opt. Lett. 36, 2053-2055 (2011).

[18] D. B. Conkey, A. M. Caravaca-Aguirre, J. D. Dove, H. Ju, T. W. Murray, and R. Piestun, “Super-resolution photoacoustic imaging through a scattering wall,” arXiv:1310.5736 (2013).

[19] P. Lai, L. Wang, J. W. Tay, and L. V. Wang, “Nonlinear photoacoustic wavefront shaping (PAWS) for single speckle-grain optical focusing in scattering media,” arXiv:1402.0816 (2014).

[20] T. Chaigne, O. Katz, A. C. Boccara, M. Fink, E. Bossy, and S. Gigan, “Controlling light in scattering media non-invasively using the photoacoustic transmission matrix,” Nat. Photonics 8, 58-64 (2014).

[21] U. Schnars and W. Jüptner, “Direct recording of holograms by a CCD target and numerical reconstruction,” Appl. Opt. 33, 179-181 (1994).

[22] E. Cuche, P. Marquet, and C. Depeursinge, “Spatial filtering for zero-order and twin-image elimination in digital off-axis holography,” Appl. Opt. 39, 4070-4075 (2000).

[23] I. M. Vellekoop, “Controlling the propagation of light in disordered scattering media,” Ph.D. thesis (University of Twente, 2008).

[24] I. M. Vellekoop and A. P. Mosk, “Universal optimal transmission of light through disordered materials,” Phys Rev Lett 101(2008).

[25] U.S. Pat. No. 8,717,574 issued on May 6, 2014, by Changhuei Yang and Meng Cui.

[26] Meng Cui and Changhuei Yang, “Implementation of a digital optical phase conjugation system and its application to study the robustness of turbidity suppression by phase conjugation,” Optics Express, Vol. 18, No. 4, published 2 Feb. 2010.

[27] http://www.alliedvisiontec.com/us/products/cameras/gigabit-ethernet/prosilica-gx/gx1920.html.

[28] http://holoeye.com/spatial-light-modulators/slm-pluto-phase-only/

[29] Zhou et. al., “Focusing on moving targets through scattering samples”, Optica, Vol. 1, No. 4/October 2014, page 227 and supplementary material.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for irradiating scattering medium, comprising:
irradiating a scattering medium with radiation from a laser, to form scattered radiation having a scattered field;
measuring a difference in the scattered field caused by motion of a moving target in or behind the scattering medium;
forming a phase conjugate of the difference to form a phase conjugate field; and
irradiating the scattering medium with the phase conjugate field using one or more radiation modulating elements.

2. The method of claim 1, further comprising:
irradiating the scattering medium with the radiation to form a speckle field in the scattering medium;
collecting, on a sensor, first scattered radiation comprising at least a portion of the scattered radiation when the moving target at a first position;
collecting, on the sensor, second scattered radiation comprising at least a portion of the scattered radiation when the moving target has moved to a second position in or behind the speckle field;
the measuring, in the sensor, comprising measuring a first complex field of the first scattered radiation and a second complex field of the second scattered radiation;
subtracting, in a processor, the first and second complex fields from each other to form the difference comprising a subtracted field;
calculating, in a processor, the phase conjugate;
outputting the phase conjugate to the modulating elements such that the modulating elements are controlled to form the phase conjugate field that focuses at the second position.

3. An apparatus for irradiating a scattering medium, comprising:
a laser for irradiating a scattering medium with radiation to form scattered radiation having a scattered field, wherein a difference in the scattered field is caused by motion of a moving target in or behind the scattering medium; and
one or more radiation modulating elements for forming a phase conjugate field used to irradiate the scattering medium, wherein the phase conjugate field is a phase conjugate of the difference.

4. The apparatus of claim 3, further comprising a spatial light modulator (SLM) having one or more pixels comprising the one or more modulating elements or a deformable mirror device (DMD) having one or more actuators comprising the one or more modulating elements.

5. The apparatus of claim 3, wherein:
the moving target has a cross-section having full width at half maximum (FWHM) of 50 micrometers or less,
the phase conjugate field forms a focus in the scattering medium having a FWHM of 50 micrometers or less, and
the focus has a peak to background ratio of at least 300.

6. A flow cytometer comprising the apparatus of claim 3, wherein the flow cytometer is for performing flow cytometry using the phase conjugate field.

7. The apparatus of claim 3, wherein:
the scattering medium has a scattering coefficient μₛ of 30 mm⁻¹ or more, and/or
the scattering medium scatters the radiation such that an intensity of transmitted radiation per solid angle and as a function of azimuthal angle has a full width at half maximum of at least 0.075 radians.

8. The apparatus of claim 3, wherein the scattering medium comprises one or more biological cells.

9. The apparatus of claim 3, wherein the scattering medium comprises water or atmosphere.

10. The apparatus of claim 3, wherein the phase conjugate field forms a focus at a depth within the scattering medium that does not transmit a detectable ballistic component of the radiation within a detection threshold of 10⁻⁸ of the radiation's power.

11. The apparatus of claim 3, further comprising:
a sensor for measuring a first complex field of first scattered radiation and a second complex field of second scattered radiation, wherein:
the first scattered radiation comprises at least a portion of the scattered radiation when the moving target is at a first position, and
the second scattered radiation comprises at least a portion of the scattered radiation when the moving target is at a second position in or behind a speckle field formed in the scattering medium when the radiation irradiates the scattering medium;
one or more processors for:
subtracting the first and second complex fields from each other to form the difference comprising a subtracted field,
calculating the phase conjugate;
outputting the phase conjugate to the modulating elements such that the modulating elements are controlled to form the phase conjugate field that focuses at the second position.

12. The apparatus of claim 11, wherein:
the sensor comprises a camera for measuring an interference of the at least a portion of the scattered radiation with a reference beam; and
at least one of the processors can:
Fourier transform the interference to form a Fourier transform;
filter out an interference term from the Fourier transform to form a filtered product; and
inverse Fourier transform the filtered product to obtain the complex field of the at least a portion of the scattered radiation.

13. The apparatus of claim 11, further comprising a digital off-axis or on-axis holography system comprising the sensor and for measuring the complex fields.

14. The apparatus of claim 11, wherein the sensor can measure the second complex field, the processors can output the phase conjugate, and the modulating elements can form the phase conjugate field within a time such that the phase conjugate field focuses on at least a portion of the moving target at the second position.

15. The apparatus of claim 11, wherein the sensor can measure the second complex field, the processors can output the phase conjugate, and the modulating elements can form the phase conjugate field within a time of 50 milliseconds.

16. The apparatus of claim 11, wherein the phase conjugate field is formed to track the moving target.

17. The apparatus of claim 11, wherein the phase conjugate field is formed to focus at a specific location along a trajectory of the moving target.

18. The apparatus of claim 11, further comprising a detector for measuring fluorescence emitted by the moving target in response to excitation by the phase conjugate field at a focus on the moving target at the second position.

19. The apparatus of claim 11, further comprising:
a Digital Optical Phase Conjugation (DOPC) device comprising:
the modulating elements imaged onto the sensor comprising a camera, and
the one or more processors connected to the camera and the modulating elements, wherein:
the DOPC device is positioned on a same side of the scattering medium as the incident radiation, to receive the scattered radiation comprising the radiation reflected and scattered from the scattering medium and the moving target.

20. A method for fabricating an apparatus for irradiating a scattering medium, comprising:
providing a laser for irradiating a scattering medium with radiation to form scattered radiation having a scattered field, wherein a difference in the scattered field is caused by motion of a moving target in or behind the scattering medium; and
providing one or more radiation modulating elements for forming a phase conjugate field used to irradiate the scattering medium, wherein the phase conjugate field is a phase conjugate of the difference.
